(19) United States
(12) Patent Application Publication
(10) Pub. No.: US 2007/0100262 A1
(43) Pub. Date: May 3, 2007

(54) Purr-like vibration device

(76) Inventors: Michael Simos, Merrick, NY (US); Roberta Daar, Merrick, NY (US)

Correspondence Address: PLEVY & HOWARD & DARCY P.C., P.O. BOX 226, Fort Washington, PA, 19034, US

(21) Appl. No.: 11/262,884

(22) Filed: Oct. 31, 2005

(51) Int. Cl. A61H 1/00

(52) U.S. Cl. 601/74; 601/70; 601/79

(57) ABSTRACT

A device for producing a cat purr-like vibration to be worn on a body part such as a wrist for therapeutic soothing and healing is disclosed. A switch provides for the continuation of vibrations as stimulated by movement across the surface of a switch, operable in both vertical and horizontal directions, whereby the vibration device emits a simulated cat purring vibration. One embodiment includes a wristband that is disposed about a wrist joint about the area of the palmar carpal ligament, the radius and the ulna bone structure and the brachioradialis muscle at the muscle position over the radius bone at the wrist to provide vibration movement; a releasable fastener for adjustably securing the wristband about the wrist joint whereby the wristband provides the support and placement for specific positioning to provide therapy at a part of the back portion of the user's wrist during use of the device.

### FIELD OF THE INVENTION

This application relates generally to devices attached to the body for providing a therapeutic result.

### BACKGROUND OF THE INVENTION

There is considerable opinion suggesting that vibrations at low frequencies and low amplitude intensities have therapeutic value. For example, scientists have shown that certain vibrations can aid bone growth, heal fractures, relieve pain, add strength and repair tendon and muscle, improve joint mobility, reduce joint swelling, and relieve breathlessness. Therapeutic frequencies for the generation of muscle strength lie between 2-100 hertz (Hz). Cat purr frequencies coincidentally correspond to vibration frequencies used in treatment for bone growth/fractures, pain, edema, muscle growth/strain, joint flexibility, dyspnea, and wounds. As many feline owners will testify, a cat's purr seems to relax them, confirming what researchers have demonstrated, that stroking a purring cat can lower human blood pressure and pulse rate, as well as increase feelings of peace and well-being. Exposure to frequencies at the 20 to 50 Hz range increases bone density (house cats generally purr in the range of 20 to 50 Hz and otherwise generate strong frequencies between 25 and 150 Hz). Therefore, it can be said that the affects of such vibration frequencies are both physical and psychological.

### SUMMARY OF THE INVENTION

According to an aspect of the present invention, a therapeutic device adapted to be worn over an affected part of the body has an outer cover having an interior cavity; a switch; and an electronic vibration device responsive to the commencement and continuation of movement across the surface of the switch, which may be operable in both vertical and horizontal directions, the vibration device emitting a simulated cat purring vibration. The device is covered by a pliable material. In one aspect of the invention, the vibration mechanism is mechanically coupled to the outer material. The device includes an electrical circuit for interconnecting the vibration device to a switch that controls the vibration device producing the simulated cat purring vibration.

According to another aspect of the present invention, a therapeutic device is worn on a body part such as user's wrist for providing vibration therapy. When worn on a wrist the device comprises in combination a wristband for being disposed about a wrist joint about the area of the palmar carpal ligament, the radius and the ulna bone structure and the brachioradialis muscle at the muscle position over the radius bone at the wrist, the wristband having a hook and loop means for adjustably securing the wristband about the wrist joint; an outer cover having an interior cavity secured to the wristband; and an electronic vibration device responsive to commencement and continuation of movement across the surface of a switch operable in both vertical and horizontal directions, the vibration device emitting a simulated cat purring vibration, and being positioned within said interior cavity. The vibration is felt in the vicinity of the wrist and also through the fingertips that move across the surface of a switch to keep the vibration active.

### BRIEF DESCRIPTION OF THE DRAWINGS

The invention is best understood from the following detailed description when read in connection with the accompanying drawing. The various features of the drawings are not specified exhaustively. On the contrary, the various features may be arbitrarily expanded or reduced for clarity. Included in the drawing are the following figures:

FIG. 1 illustrates a hand having disposed about the wrist an exemplary embodiment of the present invention.

FIG. 2 illustrates a hand having disposed about the wrist an exemplary embodiment of the present invention having an attached outer cover in the shape of a cat.

FIG. 3 illustrates an electromechanical circuit according to an exemplary embodiment of the present invention.

### DETAILED DESCRIPTION OF THE INVENTION

In the figures to be discussed, the circuits and associated blocks and arrows represent functions of the process according to the present invention, which may be implemented as electrical circuits and associated wires or data busses, which transport electrical signals. Alternatively, one or more associated arrows may represent communication (e.g., data flow) between software routines, particularly when the present method or apparatus of the present invention is a digital process.

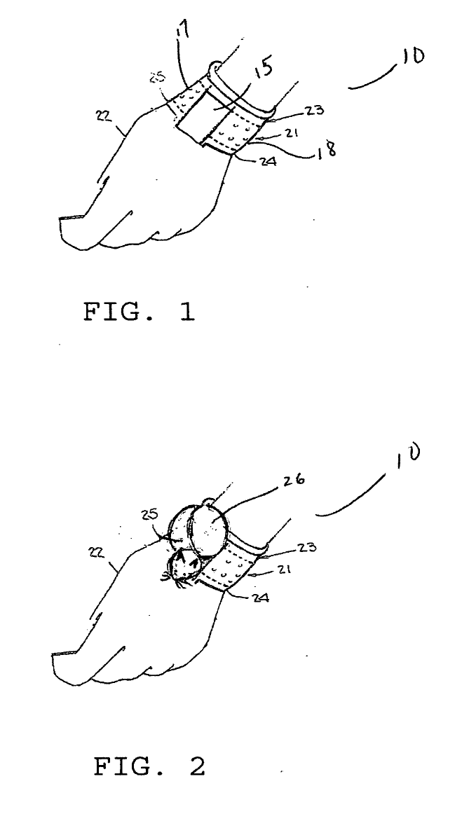

The invention is designed to be used over any part of any area of the body, which might benefit from vibrations in the specified spectrum. By way of description and not limitation, FIG. 1 illustrates one embodiment of a therapeutic device 10 disposed about the wrist in an exemplary embodiment of the present invention. The therapeutic device 10 emits a cat purr-like vibration, which is soothing and healing, and includes in combination a mounting band, such as wristband, that may be disposed about a wrist joint about the area of the palmar carpal ligament, the radius and the ulna bone structure and the brachioradialis muscle at the muscle position over the radius bone at the wrist to provide vibrational movement; a releasable fastener for adjustably securing the wristband about the wrist 21 joint whereby the wristband 24 provides the support and placement for providing therapy at a part of the back portion of the user's wrist during use of the device, the support extending from over the area of the brachioradialis muscle at the muscle's position over the radius bone at the wrist, over the transverse carpal ligament. As will be apparent from the function of the device, such a mounting band might be applied to other joints or muscles throughout the body.

As shown in FIG. 1 the therapeutic device 10 comprises an outer cover 25 having an interior cavity; and an electronic vibration device (unshown) responsive to commencement of and continuation of movement of across the surface of a switch operable in both vertical and horizontal directions, said vibration device emitting a simulated cat purring vibration, said device being positioned within said interior cavity of the outer cover 25. A simulated cat purring vibration is a low-amplitude vibration with a frequency between about 15 Hertz and about 150 Hertz. A moving pressure on the surface of a switch may cause the switch to close. The switch may remain closed for a selected period. The switch may be disposed under the outer cover, such that moving contact on the outer cover, such as by the finger of a user exerting light pressure on the outer cover, closes the switch. The switch may be configured to be responsive to contact moving only in one direction, to contact moving in both one direction and an opposite direction (such as vertical and horizontal), or in any direction.

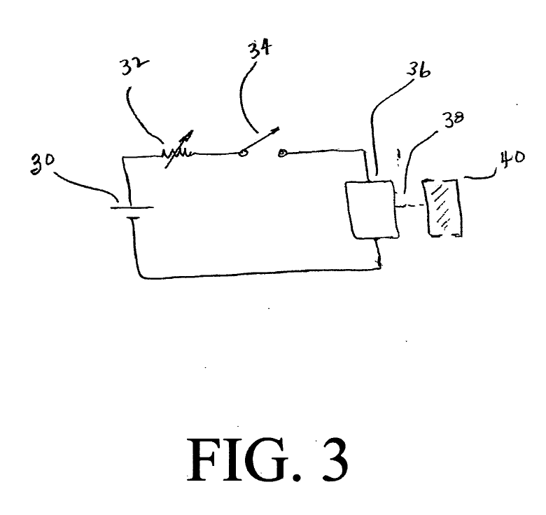

In accordance with the present invention, FIG. 1 illustrates, a wristband 24, comprising strap portions 17 and 18, securely disposed about the user's wrist joint. The wristband 24 is positioned about the user's wrist 21 approximately at the radius and ulna of the wrist 21. The wristband 24 has any suitable separable fastening means that can be employed to enable the user to easily remove and adjust the strap portions 17 and 18 about the user's wrist 21. One such preferred fastener is a separable fastener sold under the trademark “Velcro” comprising a patch of loop pile fabric that can be secured to the top part of strap portion 17, and a patch of hook type fabric that can be secured to the bottom part of strap portion 18. The same type of loop pile fabric-hook type fabric separable fastener can be used for releasably securing the extended portion of support member 15, which may be used to attach a vibration device to the wristband in the manner as described herein below. Although there is illustrated in the drawings a left hand 22 on which the device may be worn by a user, it is to be understood that the present invention is equally applicable to a right hand. The vibrations emitted by the device are felt in the vicinity of the body part, such as the wrist 21 and also through the fingertips that move across the surface of a switch 34 (FIG. 3) to keep the vibration active.

In accordance with a feature of the present invention, support member 15 is fastened to the wristband 24 along a part of the back portion of the user's wrist such that the support member is positioned over the radius bone at the wrist and transfers active vibrations from a vibrator device 25. The wristband 24 in combination with a vibration device is typically enclosed in a material 26, which may be in the shape of a cat in accordance with the present invention both positioned on a user's wrist in a manner which will tend to add a palliative effect to the user's wrist and mental state. The shape of a cat in accordance with the present invention forms an outer cover, which is generally pliable such as by way of example and not limitation, animal fur, fake fur, or other soft fabrics and materials and in one aspect of the invention coupled to the vibration device 25.

As further illustrated in FIG. 1 and FIG. 2 include a flap member 27, which is pulled over flexible support member 26 and releasably fastened to the top surface 28 thereof. Fastening the flexible support member in this manner, in addition to fastening the bottom surface of the support member to lie in against the back portion of the user's hand, provides an additional means for securing the support member on the user's hand in the proper position.

FIG. 3 illustrates one embodiment of an electromechanical circuit of the present invention that emits a vibration frequency in a range from about 15 hertz to about 75 hertz. A battery 30 supplies power to a vibration device 36 through a conventional circuit comprised of a switch 34 and a vibration control means such as resistor 32. The switch 34 provides for the continuation of movement as stimulated by movement across the surface of a switch, operable in both vertical and horizontal directions, whereby the vibration device emits a simulated cat purring vibration. The resistor limits the current to the vibration device as one means to increase or reduce the vibration frequency. The vibration device may include any electromechanical transducer, such as a disk vibrator, piezoelectric device, motor, or solenoid that produces a mechanical vibration having a frequency in a range from about 20 hertz to about 75 hertz in response to an electrical input. Mechanical connection 38 is any means that transfers the vibrations from the vibrator 36 directly to the wrist 21 or to a damping device 40. The vibration device may emit a sound at the same frequency range as the vibration frequency. Optionally, a sound emitting device may be provided to emit a sound at a frequency in a range between about 15 Hertz and about 75 Hertz. Mechanical connection 38 may, for example, be embodied in the support member 15 or integrally connected thereto. The damping device 40 may be made from any material, such as a rubber, plastic or other type of material that produces a broadly radiated vibration to the user's wrist 21 approximately at the radius and ulna of the wrist 21.

While the present invention has been described with reference to the illustrative embodiments, this description is not intended to be construed in a limiting sense. Various modifications of the illustrative embodiments, as well as other embodiments of the invention, will be apparent to those skilled in the art on reference to this description. It is expressly intended that all combinations of those elements that perform substantially the same function in substantially the same way to achieve the same results are within the scope of the invention. Substitutions of elements from one described embodiment to another are also fully intended and contemplated.

1. A therapeutic device comprising:
an outer cover having an interior cavity;
a switch; and an electronic vibration device responsive to commencement of and continuation of movement across the surface of the switch, said vibration device emitting a simulated cat purring vibration, at a frequency between about 15 Hertz and about 150 Hertz, said device being positioned within said interior cavity.

2. The device of claim 1, wherein the vibration frequency is in a range from about 15 hertz to about 75 hertz.

3. The device of claim 1, wherein the outer cover is pliable and coupled to said vibration device.

4. The device of claim 1, including a circuit for interconnecting the vibration device to the switch with the vibration device producing a simulated cat purring vibration depending on the switch activation.

5. The device of claim 4, wherein the switch is operable in both vertical and horizontal directions.

6. The device of claim 1, wherein the vibration device is one of: piezoelectric device, motor, or solenoid.

7. The device of claim 1, wherein the vibration device emits a sound.

8. The device of claim 1, wherein the vibration device emits a sound in a range from about 15 hertz to about 75 hertz.

9. A device having a wristband for providing vibration therapy worn disposed about a wrist, comprising:
means for adjustably securing said wristband about a wrist; an outer cover secured to the wristband and having an interior cavity; a vibration device responsive to commencement and continuation of movement across the surface of a portion of a switch operable in both vertical and horizontal directions, said vibration device positioned within said interior cavity and emitting a simulated cat purring vibration.

10. The device of claim 9, wherein the outer cover having an interior cavity contains a portion of the switch, a means to adjust the vibration device vibration frequency, and a mechanical connection to transfers the vibration frequency from the vibration device to the wrist.

11. The device of claim 10 further including a damping device to produce a radiated vibration to the user's wrist approximately at the radius and ulna of the wrist.

12. The device of claim 9, wherein the outer cover is in the shape of a cat.

13. A device for providing vibration therapy worn disposed about a portion of a body part, comprising:
a band;
means for adjustably securing said band about the body part; an outer cover having an interior cavity secured to the band; a vibration device responsive to operation of a switch, said vibration device positioned within said interior cavity and emitting a vibration frequency in a range from about 15 hertz to about 75 hertz.
